(19) United States
(12) Patent Application Publication
(10) Pub. No.: US 2013/0340584 A1
(43) Pub. Date: Dec. 26, 2013

(54) METHOD FOR CONTROLLING A CUTTER AND PAPER HANDLING PLANT

(71) Applicant: BOEWE SYSTEC GmbH, (US)

(72) Inventor: Bernd Hoepner, Augsburg (DE)

(73) Assignee: BOEWE SYSTEC GmbH, Augsburg (DE)

(21) Appl. No.: 13/872,724

(22) Filed: Apr. 29, 2013

Related U.S. Application Data
(63) Continuation of application No. PCT/EP2011/069032, filed on Oct. 28, 2011.

(30) Foreign Application Priority Data
Oct. 28, 2010 (DE) 10 2010 043 050.1

(51) Int. Cl. B26D 5/20; B26D 7/32; B26D 1/12

(52) U.S. Cl. CPC B26D 5/20; B26D 1/125; B26D 7/32
USPC 83/23; 83/13; 83/76.1; 83/56; 83/58

(57) ABSTRACT

In a method for cutting a paper web during movement of the same for generating a plurality of individual sheets for processing by a paper handling plant, the paper web is driven at a high web speed. The cutter is driven to cut the moving paper web into the individual sheets. The paper web can be stopped between successive cuts in a controlled manner.

### CROSS-REFERENCE TO RELATED APPLICATIONS

This application is a continuation of copending International Application No. PCT/EP2009/003742, filed May 26, 2009, which is incorporated herein by reference in its entirety, and additionally claims priority from German Application No. 10 2010 043 050.1, filed Oct. 28, 2010, which is also incorporated herein by reference in its entirety.

### BACKGROUND OF THE INVENTION

Embodiments of the invention relate to the field of paper handling, for example to the generation of individual sheets and merging the same into groups for inserting the same into one or several envelopes for dispatch. In particular, the embodiments relate to controlling a cutter for cutting a printed paper web for generating a plurality of individual sheets for processing in such a paper handling plant. Embodiments of the invention relate to the processing of a web-shaped printed material separated into sheets, wherein the sheets can be printed with individual data.

Nowadays, in the field of producing cut-size papers, such as A4, A3, 8.5×11, but also when producing large format sheets for offset printing, normally, cross cutters having rotating knives are used. This is necessitated since the paper web moves continuously and is to be cut during movement. As cutters, rotary knives can be taken into account, wherein here rotary knives are known consisting of an upper rotating knife and a lower stationary knife or also rotary cutters having two rotating knives. Further, rotary cutters having several knives or blades are also used. With these separating principles, the process following the cutting process has to be implemented for continuous operation. The advantage of this known approach is that it can be driven at very high speed and hence a very high throughput results. However, a disadvantage of these known approaches is that with a continuously running web, events necessitating stopping and restarting between two cuts, such as a malfunction in a subsequent process, cannot be dealt with. Due to the mass of applied rotary knives, known cutters require some time until they are slowed down. This results in a high proportion of waste in the products to be cut. Additionally, in the field of cut-size cutting machines, there are normally no buffers or storages that can receive the paper of the trailing paper roll when the main machine stops abruptly. This also results in trailing of the whole plant.

FIG. 1 shows a graph representing, for a continuously running material web, for example when cutting blank cut-size papers, speed across time as well as the cutting instant or the instants for cross cutting the material web. As can be seen, in this conventional approach, the speed remains constant over time, due to the rotating knife, and the cuts take place at a constant interval.

In the field of inserting, for example, printed paper webs supplied to a plant in the form of one or several rolls are cut into individual letterheads and compiled to sheet groups for a customer according to the individual printed data, folded, possibly provided with a supplement and then inserted into an envelope.

In the field of inserting, it is of enormous importance that the process can be stopped at any time without damaging the products. Additionally, the position of the products has to be known, so that the data of the product can be correctly allocated. In the field of inserting, so far, cutters are used that operate in start/stop operation. Here, advantageously, a guillotine knife (stroke knife) is used but also respective round knives. Stroke knives comprise either one or two knife edges, wherein a stationary stroke knife or guillotine knife can only cut when the web stands still. Thus, the web is advanced in a clocked manner and stopped for every cut, wherein this approach originated from the fact that also the further processing is normally processed in a clocked manner or includes clocked processes. The advantage of this approach is that with a non-continuously running web, events in the subsequent processing plant can be easily be dealt with, in particular events necessitating stopping and restarting between two cuts, e.g., malfunctions in a subsequent process or subsequent process operating times of different length, as occur, for example sheet groups of different sizes have to be compiled from a plurality of individual sheets, and subsequently the readily compiled group is to be passed on for further processing, for example from the collecting station to a subsequent station, for example the inserter or a preceding folding mechanism or a provided gathering web. A significant disadvantage of this known approach is, however, that due to the clocked transport only low performance can be obtained, compared to the performance that can be obtained with continuous transport. A further disadvantage is the continuous load of the paper web, where the continuous start/stop movement results in the introduction of a high degree of stress and tensions into the paper web, which can result in web cracks which further reduces performance or throughput.

FIG. 2 shows a graphical illustration of material web running in a clocked manner, as it is used in currently known inserting machines. As can be seen, the speed profile of the material web is such that starting from instant 0 an acceleration of the paper web to the desired speed results. Just before the cut, the speed is decelerated until standstill of the paper web, such that the cut is performed when the web stands still. This pattern is repeated over time, namely following the cut, acceleration of the web to the desired speed and prior to the next cut, decelerating the paper web to a standstill to again perform the cut.

An approach for optimizing cycle times in a cutter operating in start/stop operation is described, for example, in DE 38 34 979 A.

### SUMMARY

According to an embodiment, a method for cutting a paper web during movement of the same for generating a plurality of individual sheets for processing by a paper handling plant may have the steps of: driving the paper web at a high web speed; and driving a rotary cutter to cut the moving paper web into the individual sheets; wherein the paper web runs continuously between two cuts; and wherein, in case of an event, the paper web can be stopped in a controlled manner prior to the next step.

According to another embodiment, a method for controlling a rotary cutter for cutting a printed paper web during movement of the same for generating a plurality of individual sheets for processing by a paper handling plant, comprising the steps of: feeding the printed paper web at a predetermined web speed; and driving the rotary cutter at a predetermined cutter speed; wherein prior to cutting the printed paper web for generating at least one predetermined individual sheet, a cutting instant for cross cutting the paper web is determined based on first information obtained from the printed paper web and/or from a job description, and based on second paper handling plant specific information; wherein the web speed and/or the cutter speed are adjusted such that the paper web is cut at the specific cutting instant for generating the at least one predetermined individual sheet, and wherein the paper web and the rotary cutter are stopped prior to reaching the determined cutting instant if a control signal indicates that a cut is undesired.

Another embodiment may have a computer program product having a computer program stored on a machine readable carrier for performing, when the computer program is executed on a computer or by a control, the inventive method for cutting a paper web during movement of the same.

According to another embodiment, a paper handling plant for processing individual sheets in groups consisting of one or several individual sheets may have: a paper web feed for feeding the paper web to the paper handling plant; a rotary cutter for cross cutting the paper web to generate the individual sheets for further processing in the paper handling plant; one or several processing stations subsequent to the rotary cutter; and a control that is effective to control the rotary cutter according to the inventive method for cutting a paper web during movement of the same.

Thus, embodiments of the invention enable flexible reaction to the processing (in particular changes of conditions during processing) of the sheets. Also, malfunctions in the subsequent processes can also be dealt with in time, such that waste is reduced or even prevented. Embodiments of the invention effect the adjustment of both the web speed and the cutter speed. Other embodiments of the invention effect the adjustment of either the web speed or the cutter speed. According to embodiments of the invention, the first information is obtained from the printed paper web and the job description. In other embodiments of the invention, the first information is obtained from the printed paper web or the job description.

According to embodiments of the invention, in the paper handling plant specific information is obtained from the paper handling plant (feedback), for example via sensors or the same. Alternatively, the paper handling plant specific information is calculated and provided in advance, for example, based on the job description of a job and/or the configuration of the paper handling plant. According to other embodiments of the invention, the paper handling plant specific information is partially obtained and provided from the paper handling plant and partly calculated in advance based, for example, on the job description of a job and/or the configuration of the paper handling plant.

According to embodiments of the invention, the cutter speed is defined by the speed at which the cutting elements of the cutter are moved, for example a speed at which a stroke knife is moved up and down or a speed at which a rotary knife rotates.

Thus, embodiments of the invention combine the advantages of the above described methods as known in that continuous cutting of the paper web takes place as long as this is useful and necessitated. The sheets are cut while the paper web is running, wherein, however, this process can be stopped at any time so that the advantage of the clocked method is maintained. Although, however, by specific deceleration of the material web and respective control of the cutter a longer time can be generated between two cuts, such that known longer process steps or malfunctions in subsequent processing can already be dealt with in advance. With respect to the obtainable speed in processing the paper web, the embodiments of the invention provide advantages, since operation can take place at higher speed, wherein at the same time the application range of the cutter is widened. Further, it is also possible to operate with the same throughput in continuous operation as in start/stop operation, but at a lower speed, such that a load of the paper web, e.g., tensions in the web and the cutter is reduced.

Embodiments of the invention provide a method as discussed above, wherein it is intended that the web speed and the cutter speed are adjusted such that the web speed and the cutter speed have already assumed the desired adjusted speeds prior to cutting, i.e., prior to the instant or point in time for cross cutting, i.e., are no longer in the acceleration phase but are already at the transport speed for the web and the necessitated cutting speed for the desired cross cutting. Also, according to embodiments, it can be possible to adjust the web speed and the cutter speed according to a predetermined profile. As an example, for specific instants for cross cutting that are known in advance, or for intervals between successive instants for cross cutting, for example, speeds for the web and the cutter, which are stored in tables, can be selected. Also, a specific profile can be predetermined depending on the job to be processed. If it is known from the job or job description provided to the plant for processing that, for a first time period, groups of a first size and, for a further time period, groups of another size and, for a further subsequent time period, groups of again another size are to be generated, a respective profile can be provided that switches to the second profile after the first period and then to the third profile in order to adjust the desired instants for cross cutting.

According to embodiments of the invention, the respective cutting instant for the plurality of individual sheets to be generated for a job is determined in advance, such that subsequent to this determination of a cutting instant or cross cutting instant for the at least one individual sheet, the cutting instant or the cross cutting instant is determined for at least one further individual sheet and that the values determined for the at least one further individual sheet are provided for adjusting the web speed and the cutter speed in order to be retrieved after generating the at least one individual sheet to adjust the plant to the next cross cutting instant.

According to embodiments, in the predictive cutting, at first, a first time period is defined between two successive cuts. For processing at least one individual sheet after cutting, a second time period is determined, which indicates, for example, how long processing of the at least one individual sheet either in the whole handling plant or in individual modules of the same takes, wherein, for this, information both from the paper web/the job description and information from the paper processing plant is used. If it becomes clear that the second time period exceeds the first time period, the cutter speed and the web speed are acted upon in order to adjust the same, such that the first time period is longer than or equal to the second time period. According to this embodiment, it is ensured that the time period necessitated for a process step within the plant is longer than the time period between two cuts, such that when an error or a delay of the processing of the sheet within the plant occurs, a reaction can be effected so that the speed of the cutter and the paper web is adjusted, for example, reduced for compensating the longer processing of the at least one individual sheet without having to stop the cutter. Optionally, the cutter can also be stopped.

According to embodiments, the first information and the second paper handling plant with the specific information comprises the following parameters:
the individual sheets to be processed by the paper handling plant, and/or
the type of processing the individual sheets in the paper handling plant, and/or
a capacity of the paper handling plant for processing the individual sheets.

The parameters relating to the type of processing the individual sheets in the paper handling plant can comprise a size of the groups to which the separated individual sheets are combined and/or an allocation of several cut individual sheets to a group and/or an end of a group. The parameters relating to the individual sheets to be processed by the paper handling plant can comprise physical characteristics of the paper web or the at least one individual sheet. Parameters relating to the capacity of the paper handling plant can comprise a number of individual sheets simultaneously processable by the paper handling plant or a module of the same and/or a speed at which the plant or a module of the plant can process the individual sheets.

According to embodiments of the invention, the paper web can be printed in a multi-use manner, wherein the paper web for generating the individual sheets is cut along the conveying direction prior to cross cutting. Adjusting the web speed and the cutter speed can also include stopping the paper web and stopping the cutter. Alternatively, a longitudinal cut can also take place earlier, whereby two parallel webs are generated that are placed on top of one another and are cross cut together.

The cutter can be a rotary cutter having one or several knives or a laser cutter. Further, any cutters can be used that allow cross cutting of a paper web during its transport (continuous cutters).

The paper handling plant or the module of the same can comprise an inverter, a folding mechanism, a collecting station and/or other known paper handling stations or modules, wherein the second paper handling plant specific information also comprises a maximum number of sheets that can be processed simultaneously.

According to embodiments of the invention, the cutting instant for cross cutting the paper web is further determined based on third information indicating a malfunction or a malfunction event in the paper handling plant or in a module of the paper handling plant.

### BRIEF DESCRIPTION OF THE DRAWINGS

Embodiments of the present invention will be detailed subsequently referring to the appended drawings, in which:

FIG. 1 is a graph representing the speed against the time as well as the instants for cross cutting with a continuously running material web, for example when cutting blank format papers;

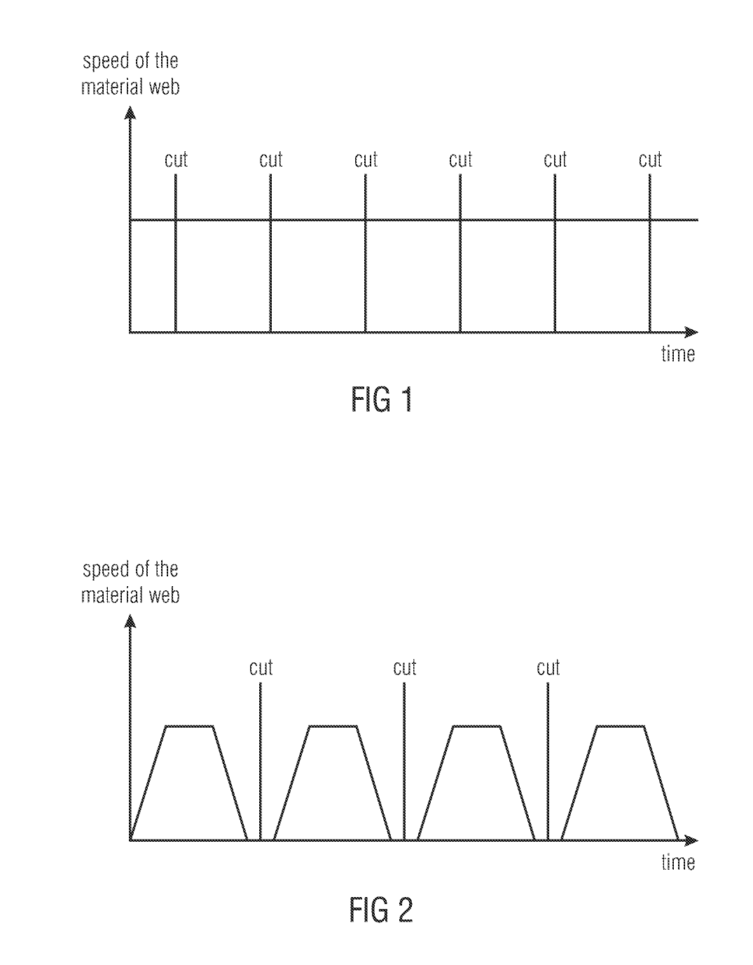

FIG. 2 is a graph representing the speed against the time as well as the instants for cross cutting with a material web running in a clocked manner;

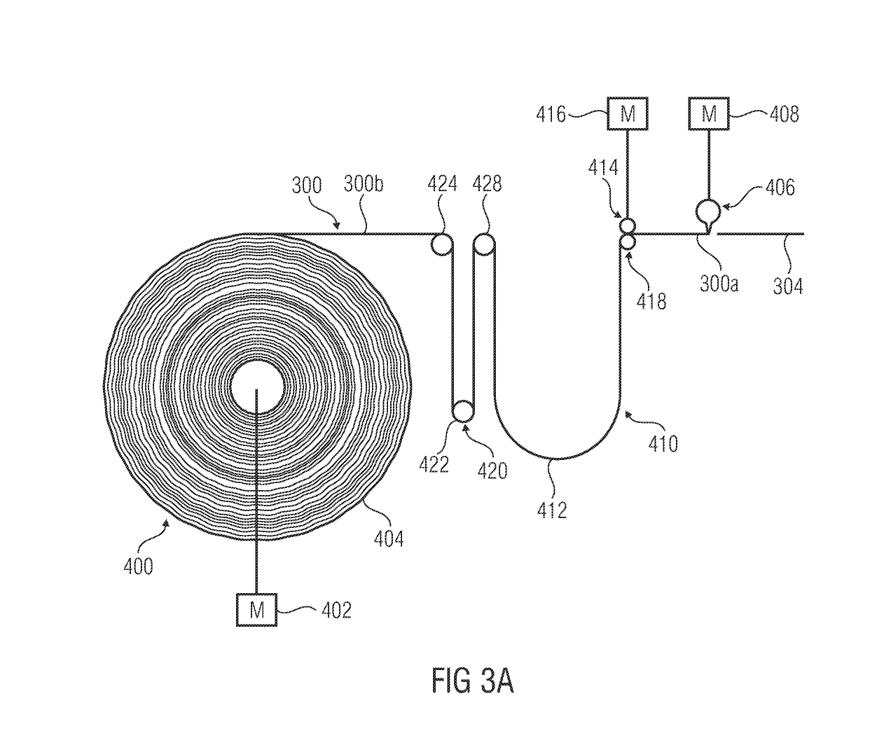

FIG. 3(a)-(d) show different embodiments of the invention;

FIG. 4(a) is a speed profile of the paper web as it is obtained according to embodiments of the present invention;

FIG. 4(b) is a curve of the speed of the paper web according to the embodiments of the invention similar to FIG. 4(a), wherein here, however, the paper web is stopped completely between two cuts;

FIG. 5 is a speed profile for the cutter as it is obtained according to embodiments of the present invention;

FIG. 6 is a curve of the speed for the cutter according to embodiments of the invention similar to FIG. 4(a), wherein here, however, the cutter is stopped completely between two cuts;

FIG. 7 is an embodiment of the method for controlling a cutter;

FIG. 8 is an example for determining an instant for cross cutting according to embodiments of the present invention;

FIG. 9 is a schematic illustration of a paper handling plant according to embodiments of the invention; and

FIG. 10 is a schematic illustration of a paper handling plant according to a further embodiment of the invention where the control is arranged in the cutter; and

FIG. 11 is a schematic illustration of a further paper handling plant according to another embodiment of the invention.

### DETAILED DESCRIPTION OF THE INVENTION

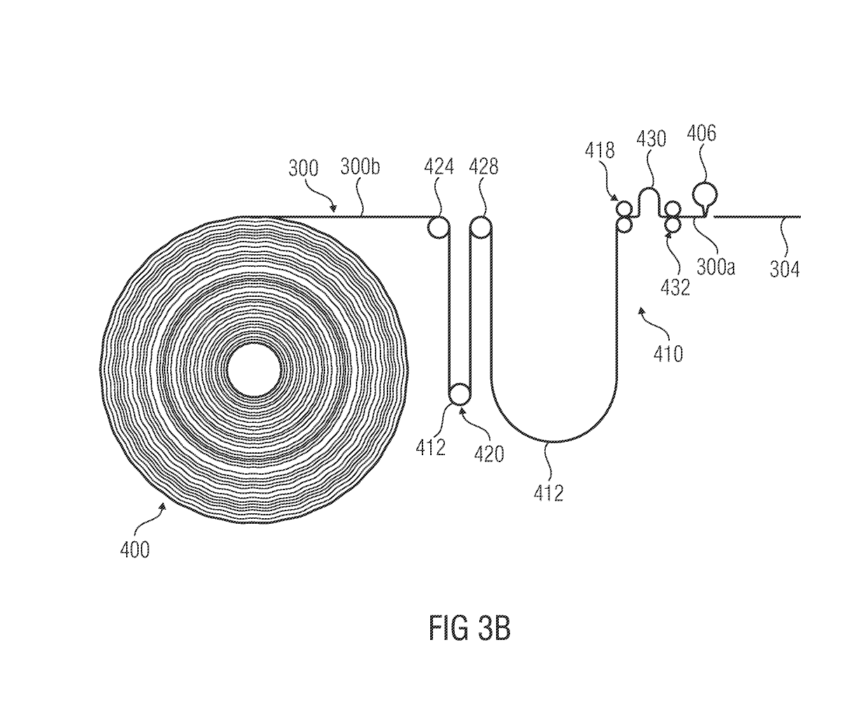

In the following, based on FIG. 3(a) to (d), embodiments of the invention will be discussed in more detail. FIG. 3(a) shows a schematic illustration of part of a paper handling plant that serves to generate a plurality of individual sheets 304 from a printed or unprinted paper web 300. The paper handling plant comprises a paper supply 400 providing the paper web 300. In the embodiment shown in FIG. 3(a), the paper web 300 is implemented in the form of a paper roll provided by the paper supply 400. The paper supply 400 comprises an unrolling means comprising a motor 402 to move the paper roll 404 at a predetermined speed to provide a predetermined length of the paper web 300 within a predetermined time period. Here, it should be noted that the present invention is not limited to providing the paper web 300 in the form of a roll 404, but that the paper web can also be provided by other suitable means.

The paper handling apparatus further comprises a cutter 406, advantageously a rotary cutter cutting the paper web 300 during movement of the same into the individual sheets 304. The cutter 406 is driven by a motor 408. A decoupling means 410 is provided between the paper supply 400 and the cutter 406, which serves to decouple the paper web 300. The decoupling means 410 is implemented to form a loop 412, such that a predetermined length of the paper web 300 is received in the loop 412 between the paper supply and the cutter 406, which effects decoupling of the part 300a of the paper web 300 between the decoupling means 410 and the cutter 406 and the part 300b of the paper web 300 between the paper supply 400 and the decoupling means 410.

The apparatus further comprises a feeding drive 414, comprising in the example shown a roller pair 418 driven by the motor 416. The feeding drive 440 is arranged between the decoupling means 410 and the cutter 406 and serves to drive the paper web 300 in the region between the decoupling means 410 and the cutter 406 to feed the same at a high web speed to the cutter 406, wherein, however, the feeding drive is provided to allow controlled stopping of the paper web, more accurately the portion 300a of the same arranged between the decoupling means 410 and the cutter 406 within a cutting cycle, i.e. between two immediately successive cuts of the cutter 406.

Thus, FIG. 3(a) shows a paper handling apparatus according to embodiments of the invention that serves to cut the paper web 300 during the movement of the same to generate a plurality of individual sheets 304 for processing. The paper web 300 is driven at a high web speed, wherein a high speed in the context of the subject matter of the present application means that this speed is higher than 1 m/s, wherein a maximum speed is, for example, at more than 10 m/s. A high web speed is desirable to obtain a predetermined number of cuts per hour, e.g. at least 12,000 cuts per hour for generating individual sheets of the format A4. At the same web speed of 1 m/s or more, more cuts per hour can be obtained for smaller formats, or less cuts per hour for larger formats.

The cutter 406 is driven by means of the motor 408, to cut the moving paper web 300 into the individual sheets 304, wherein, according to embodiments, due to the provision of the decoupling means 410 and the drive 414 the paper web can be stopped between successive cuts, for example in the case of an error in the processing of the individual sheets in a subsequent station.

FIG. 3(a) further shows a means 420 which is provided between the paper supply 400 and the decoupling means 410 and serves to keep the paper web 300 tight between the paper supply 400 and the decoupling means 410, wherein a so-called dancer roll 422 is provided for this. Thus, the means 420 effects that the paper web 300 is tight between the paper supply 400 and the decoupling means 410, by using the dancer roll 422 and the deflection rollers 424 and 428, wherein this, however, effects no decoupling, since the dancer roll 422 is provided to maintain tightness in the paper web 300, wherein decoupling takes place via the decoupling means 410 or the paper buffer in that the paper web is not tight within the loop 412.

The spacing between decoupling means 410 and drive 414 is selected to be as small as possible to keep the mass of the portion of the paper web 300 to be moved by the drive 414 as small as possible, whereby fast stopping between successive cuts is enabled.

Thus, according to the embodiments described based on FIG. 3(a), the above described problems occurring in known approaches are prevented. According to the invention, an approach is provided that increases the throughput during cutting and simultaneously allows necessitated stopping of the paper web. Thus, the advantages of a start/stop cutter (preventing an undesired cut) and a continuous cutter (high throughput) are combined—by preventing their disadvantages. Instead of the conventional start/stop cutter, a continuous cutter, such as a rotary cutter, is used, such that the paper web can be cut during transport, i.e. without stopping the same. Thereby, an increased throughout is obtained with respect to the start/stop approach, since a higher web speed can be used that results in a desired number of individual sheets in a predetermined time period. For realizing the option of being able to stop the cutting process at any time, which is desired in the field of inserting, without damaging the products, i.e. the paper web or the individual sheet, the plant is configured such that the paper web can be stopped in a controlled manner within a cutting cycle. According to embodiments, controlled stopping is enabled by the feeding drive and/or the decoupling means. In such embodiments, controlled stopping is enabled due to decoupling, since only the part 300a of the web having a low mass and inertia has to be stopped or immediately stopped, the remaining part 300b having higher mass/inertia is stopped in a slower manner, wherein part of the paper web is received in the decoupling means (e.g. by increasing the loop).

Known, continuously operating cutters allow stopping the paper web by introducing an element (e.g. a rake) into the transport path in front of the cutting element, which does prevent the cut but at the same time has the effect that the paper web is crushed and possibly damaged in front of the element. In this case, for example, significant user interaction is necessitated to bring the paper web, which has been stopped in an uncontrolled manner, into a state allowing further cutting. This results in an undesired decrease of throughput and increases waste. In contrast, it is a further advantage of the invention that the paper web is stopped in a controlled manner, such that immediately after stopping restart of the plant is possible, wherein, according to embodiments, no user interaction is necessitated. The plant can be restarted, for example immediately after removing the error in a subsequent processing station that caused the stopping (see below) or after a short time period, e.g. within 1, 2 or more cutting cycles.

According to the presented embodiment, the decoupling means 410 is arranged in front of the cutter 406 to receive part of the paper web in the form of the loop 412. Thereby, the part of the paper web 300a to be fed to the cutter is decoupled from the part of the paper web 300b, which is provided to the decoupling means 410, such that in the case of stopping the cutter only the part of the paper web arranged between the decoupling means and the cutter has to be stopped by the conveyor elements 418 of the drive 414, wherein this part has a lower mass compared to the overall length of the moved paper web, whereby stopping within a cutting cycle is enabled. The portion 300a of the paper web 300 is advanced between two successive cutting instants or within a cutting cycle in the direction of the cutter 406, wherein the paper web 300 or the portion 300a can be stopped as long as the advance has not exceeded a predetermined threshold.

As has been mentioned, the inventive approach combines the advantages of continuous cutters and start/stop cutters by using a decoupling means 410 with a continuously operating cutter. Such decoupling means are so far merely known in the context of start/stop cutters, see, for example, DE 10011006 A1. Due to the usage of these decoupling means, so far only used in start/stop cutters, also in continuous cutters, it is possible to prevent the above stated disadvantages of a continuous cutter with respect to stopping the paper web.

Continuous cutters as known operate, for example, with a paper web that is tight at all times. Tightening of the web is effected, for example, via the above mentioned dancer rollers and deflection rollers, however, this does not effect any decoupling. Thus, in conventional continuous cutters, a feed drive pulls the web from the roller to the cutting element, such that a high mass having high inertia has to be moved, such that no secure stopping within a cutting cycle is possible. An example for a continuously operating cutter moving the whole paper web from the roller to the cutting element is described in EP 0771623 B1. Here, the web is not decoupled in the feeder, as mentioned, i.e. the web is continuously under tension and the whole mass of the web has to be moved. In fact, in such continuous cutters, it is basically desirable to keep the web under tension to obtain a necessitated cutting accuracy. In plants driving at different speeds, these speed differences can be compensated by the above mentioned dancer rollers. However, decoupling is not provided in continuously operating cutters.

By the above described approach, the throughput during cutting is increased due to the continuous cutting process, wherein the above described implementation of the assembly allows timely stopping of the paper web within a cycle (between two immediately successive cuts), such that undesired waste can be prevented or at least significantly reduced.

Based on FIG. 3(b), a further embodiment of the present invention will be discussed, which is similar to the embodiment shown in FIG. 3(a). Different from FIG. 3(a), the decoupling means 410 is implemented to form a first large loop 412, as well as subsequent thereto, i.e. between the loop 412 and the cutter 406, a further smaller loop 430. In the embodiment shown, the feeding drive 414 comprises two roller pairs, i.e. the roller pair 418 already mentioned based on FIG. 3(a), as well as the roller pair 432 following the second loop 430. Thus, the implementation illustrated based on FIG. 3(b) allows even better decoupling of the web portions 300a and 300b and even more reliable stopping between two successive cuts.

FIG. 3(c) shows another embodiment, which is similar to the one in FIG. 3(a), wherein however the distance between decoupling means 410 and means 420 is larger. Otherwise, the functionality of the assembly shown in FIG. 3(c) corresponds to the one of FIG. 3(a).

FIG. 3(d) shows again a further example for the implementation of the assembly, which is similar to FIG. 3(b), but without the large loop but only with the smaller loop 430.

In the embodiments described based on FIG. 3(a) to FIG. 3(b), the paper web 300 can be printed. In such a case, it can further be provided that the cutting instant for cross cutting is determined prior to cutting the printed paper web 300. This is performed according to embodiments which will be described in more detail below based on first information which is obtained from the printed paper web 300 and/or from a job description, and based on second paper handling plant specific information. The web speed and/or the cutter speed is adjusted such that the paper web 300 is cut at the specific cutting instant for generating the at least one predetermined individual sheet 304, 306. Further, stopping the paper web 300 can be controlled depending on the read first information from the printed paper web 300 and from second paper handling plant specific information. Examples for the first information from the second paper web 300 and the second paper handling plant specific information will be discussed below.

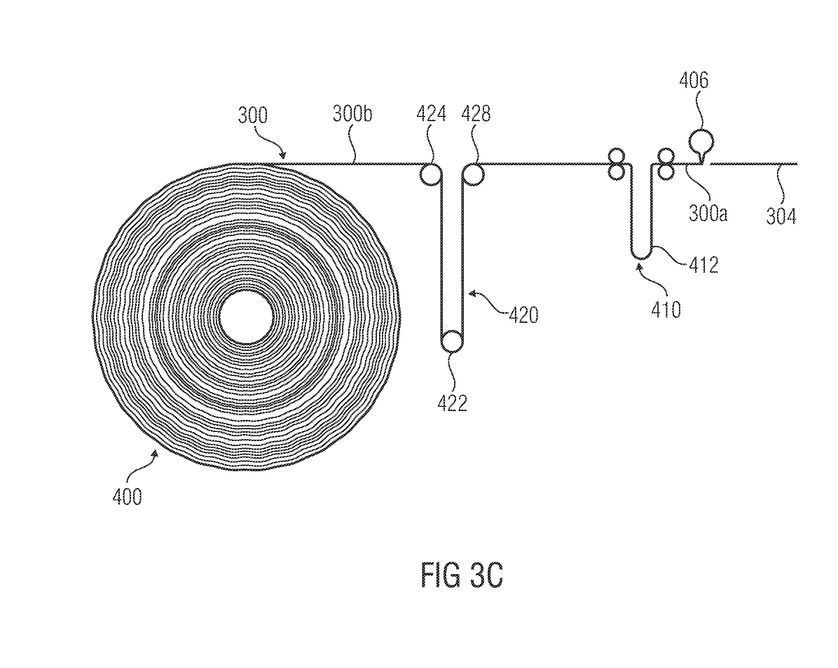

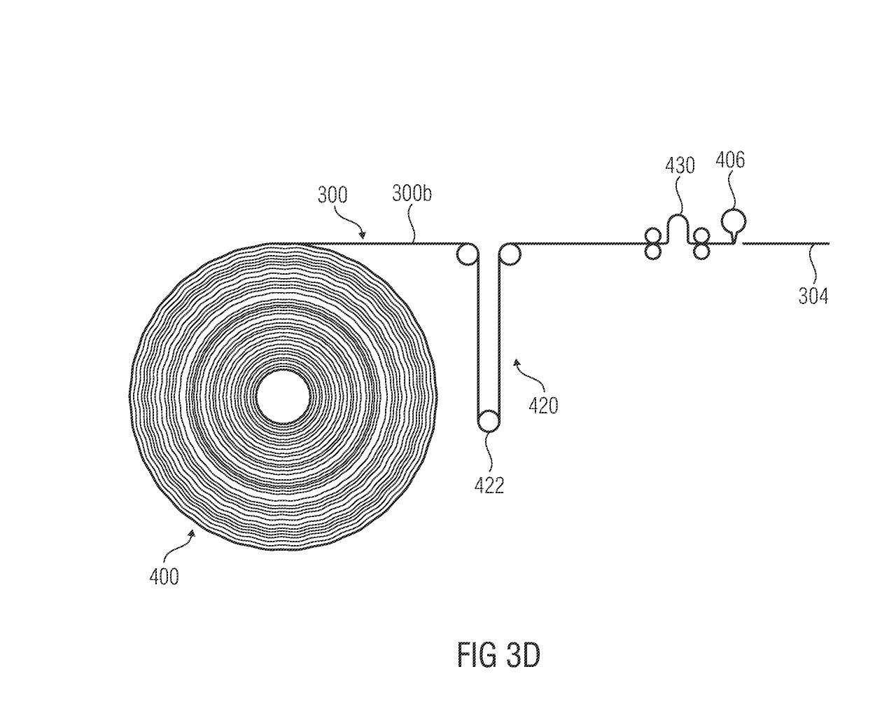

In the following, further embodiments of the invention will be explained. FIG. 4(a) shows a speed profile as it is obtained according to embodiments of the present invention. The course of the speed of the material web is plotted against the time. As can be seen from FIG. 4(a), the cuts are not spaced apart from one another in a fixed pattern as regards to time, but the spacing varies. Subsequent to a first cut at the time t1, it is detected, e.g., based on information from the job description and based on signals from the downstream paper handling plant, e.g. based on paper handling plant specific information or signals, that processing of the sheet which has just been cut will take longer. Thus, the cutting instant or the instant for cross cutting for the next sheet is determined again, and this instant for cross cutting can be obtained by reducing the speed for a time period between t1 and t2 and is increased again starting from t2 to the next instant for cross cutting t3. As can be seen, the speed of the material web has obtained the desired speed already shortly before the time t3, such that the same prevails at the time of the cut. The subsequent three cuts are performed at the same spacing at times t4, t5 and t6. After the cut at the time t6, it is again determined that a longer interval to the next instant for cross cutting is necessitated, such that the material web is decelerated again (see t7). Although, based on FIG. 4 (a), an example has been described where only the material web speed is changed, it should be noted that additionally or alternatively also exclusively the rotation speed of the rotary cutter can be changed, such that in cooperation with the changing web speed and the changing cutting speed, a respective deceleration of the cutting process can be effected.

With respect to conventional technology, the performance of a cutter arranged in an input channel of a paper handling plant can be increased by using a round knife for the cut, which cuts when the material web is running The aim is to let the web run continuously between two cuts, which shortens the time between two cuts, which results in higher performance. This is desirable, for example, between times t3 and t6 in FIG. 4(a). A typical situation in which this occurs is the collection of many sheets into a larger group, since the collecting station can also receive sheets in tight sequence. When the end of the group is detected, for example, at the time t6 in FIG. 4(a), the material web can be stopped or decelerated, such that up to the next cut at t7, again performed when the material web is running, enough time has passed so that the collecting station can change the group or can provide an empty collecting tray for receiving a new group.

FIG. 4(b) shows a course of the speed according to embodiments of the invention similar to FIG. 4(a), wherein here, however, the paper web is completely stopped between two cuts, namely between the cuts at the time t1 and t3 and between (see time t7) the cuts at time t6 and t8, but has, however, for the subsequent cut at time t3 or t8, again achieved the necessitated speed for the cut.

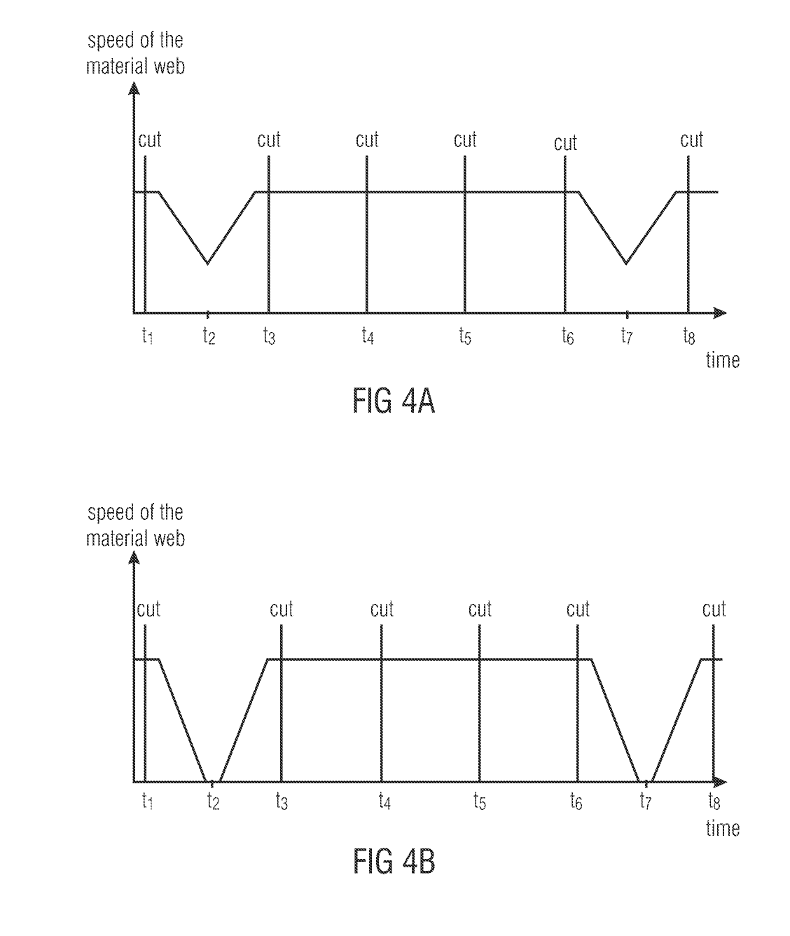

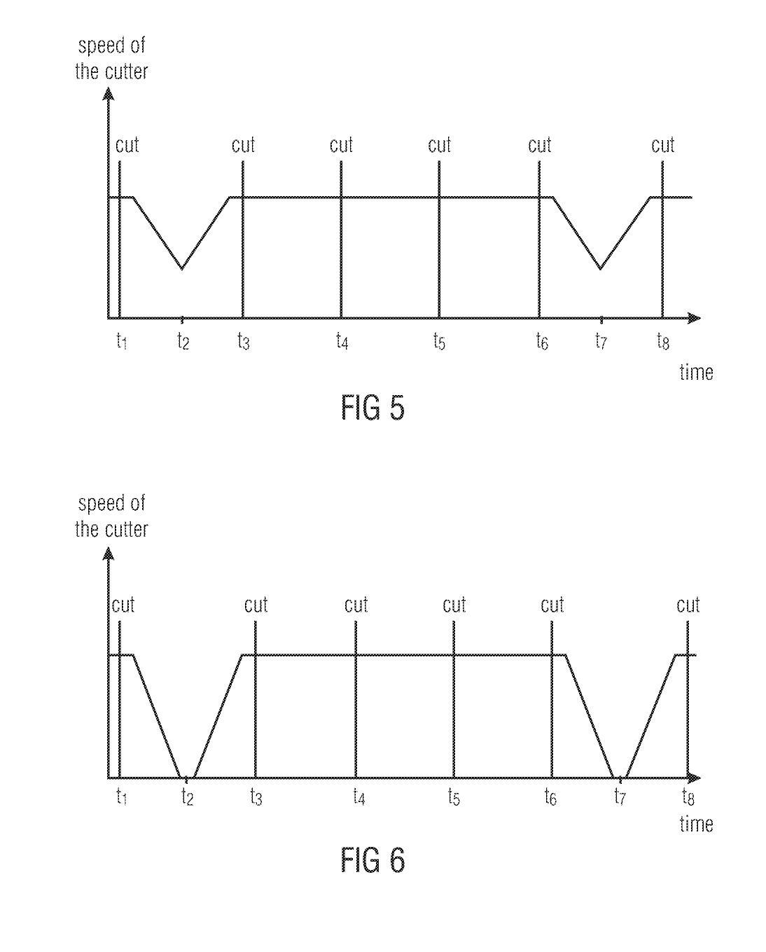

Here, it should be noted that depending on the conditions, for example, depending on the availability of the plant and the job description, the inventive control can also be switched such that switching between the continuous operation and the start/stop operation of the cutter can be performed. This can take place, for example in dependence on a format length of the individual sheets to be generated or in dependence on instructions in the job description. Further, provision can be made to adjust the predetermined cutter speed between the cutting instants during continuous operation, depending on the format to be generated. In other words, for a shorter format of at least one individual sheet to be generated, the cutter speed can be increased independent of the web speed or can be reduced for a longer format. FIGS. 5 and 6 show, similar to FIGS. 4(a) and 4(b) a speed profile only for the cutter, as it is used according to embodiments for different formats. In FIG. 5, between the cuts at times t₁ and t₃, the cutter speed, for example the rotational speed of a rotary knife is reduced, such that the time between t1 and t3 is longer than between the subsequent cuts. Hereby, a sheet is generated at t3, which has a larger format, e.g. longer than a sheet cut at t4. Alternatively, the cutter speed can also be increased between two cuts (not shown in FIG. 5) e.g. for cutting a shorter format. FIG. 6 shows that the cutter can also be stopped when, for example, the reduction of the speed is not sufficient to generate the desired format length.

As mentioned, the start/stop operation can be selected due to the format size, for example for a paper having a length of four inches, the acceleration path can be too short, since the spacing from sheet to sheet is too short considering the tilted installation of the knife with respect to the format length. Thus, for short formats, start/stop operation can be provided. Start/stop operation can be desirable when, for example, a so-called strip cut is to be made where narrow cross strips are to be cut from the paper web between successive individual sheets.

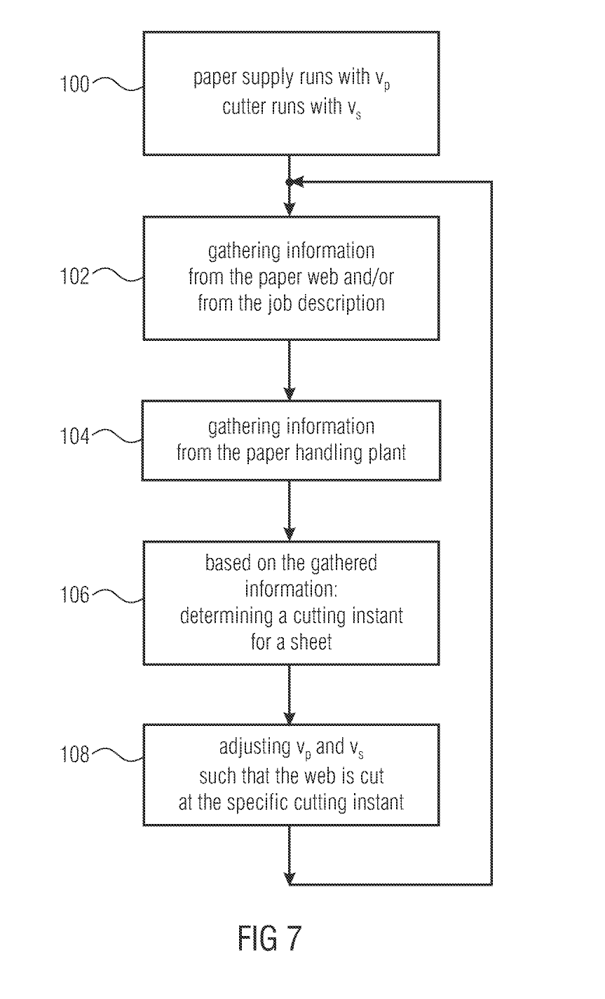

Based on FIG. 7, an embodiment of the method for controlling a cutter will be discussed in more detail below. Starting point is step 100, according to which the paper feed runs at a speed v_{P} and the cutter at a speed v_{S}. In step 102, information is gathered from the paper web and/or from the job description. In step 104, information is gathered from the paper handling plant. It should be noted that steps 102 and 104 can also be performed in a common step or in reverse order. The gathered information is, for example, parameters, stating the individual sheets to be processed by the paper handling plant, and/or stating the type of processing of the individual sheets in the paper handling plant, and/or describing the capacity of the paper handling plant for processing the individual sheets. For example, the size of the groups to be processed, i.e. the number of individual sheets to be combined into a group and/or an association of several individual sheets to a group and/or an end of a group can be detected. Also, physical characteristics of the paper web to be processed or the at least one individual sheet can be detected, for example the type of paper, in particular its weight, its surface roughness and the same, wherein these parameters in particular have an influence on the processing of the at least one individual sheet after cutting. Also, the paper handling plant can indicate how many individual sheets can be processed simultaneously by the same or a module of the same and/or at what speed. For example, it can be stated how many sheets can be received maximally within a collecting station and can be output together, which can again be conditioned by downstream modules, for example by the maximum number of individual sheets that a folding mechanism can process simultaneously.

As soon as this information is present, according to embodiments of the invention, an instant for cross cutting at least one individual sheet to be generated is determined in step 106 based on the gathered information, and in step 108, the speeds v_{P} and v_{S} are adjusted such that the paper web that is already printed with information for the individual sheets is cut at the desired or determined time for cross cutting. Subsequently, the method is repeated to realize a continuous predictive cutting process.

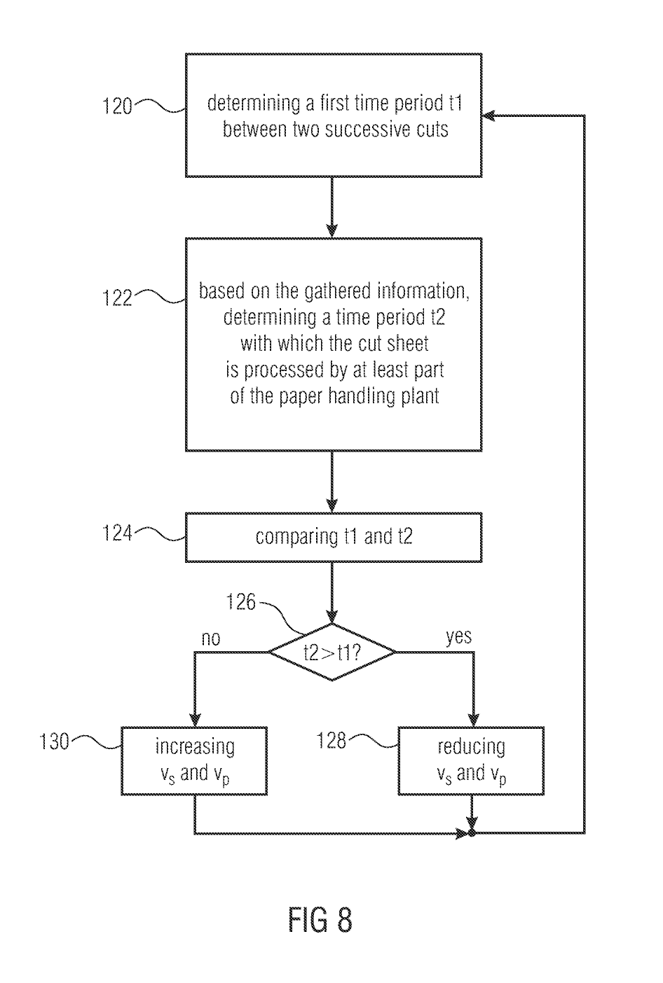

FIG. 8 shows an example for determining an instant for cross cutting, wherein, according to the shown embodiment in step 120, first, a first time period t1 is determined, which lies between two successive cuts. Subsequently, based on the above stated information, it is estimated how long processing of at least one cut individual sheets by the paper handling plant or at least part of the same will take, and this time period is determined as time period t2 in step 122. Subsequently, in step 124, a comparison of t1 and t2 takes place. If it results in step 126 that the second time period is longer than the first time period, in step 128, the cutter speed v_{S} and/or the web speed v_{P} is reduced. Otherwise, where it is determined that the time period t₂ is shorter than the time period t₁, in step 130, the speeds are increased. Then, the method returns to step 120. If the time period t2 is equal to the time period t1, advantageously, no change of speeds will take place.

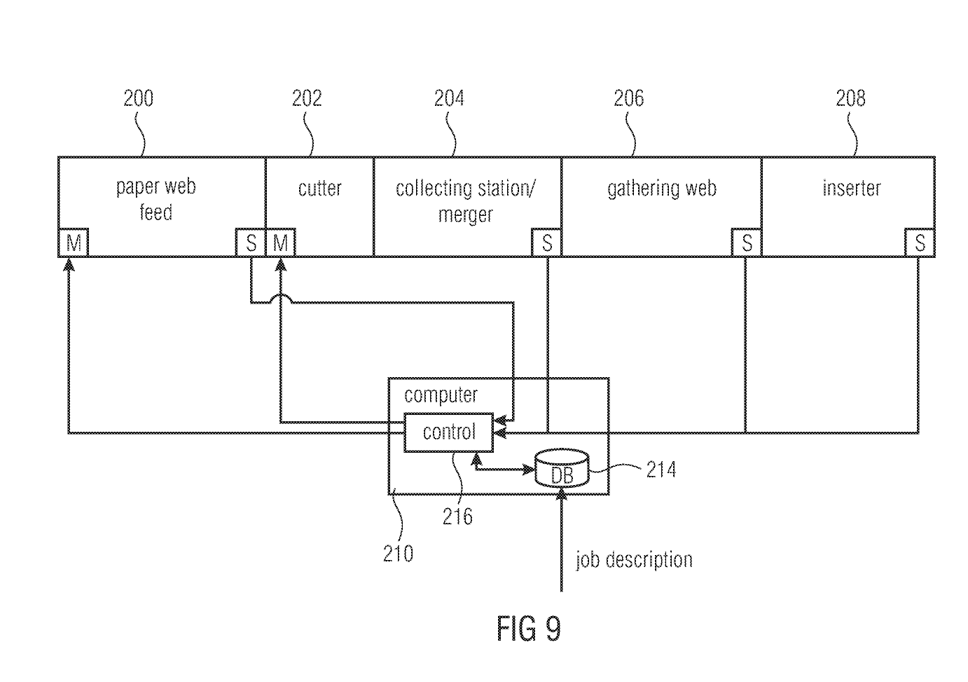

FIG. 9 shows a schematic illustration of a paper handling plant according to embodiments of the invention. The plant comprises a paper web feed 200 followed by a cutter 202, for example a rotary cutter or a laser cutter. The cutter 202 separates the paper web fed by the apparatus 200 into individual sheets which are then output to a collecting station 204. If the paper web is printed in a multi-use manner, the cutter 202 also comprises a cross cutter and the collecting station 204 comprises a merger bringing the two sheets applied in parallel at the output of the cutter 202 into a superimposed arrangement and disposes them in a collecting tray of the collecting station. The collecting station can be followed by a gathering web 206, which serves to add supplements to the collected group that is output from the collecting station 204. An inserter 208 is attached to insert the groups into respective envelopes. As can be seen in FIG. 9, the arrangement further comprises a computer 210 comprising a control 212 as well as a database 214. The control serves to control the different modules of the paper handling plant for cooperation of the same, wherein FIG. 9 merely shows the connections between control and modules relevant to the subject matter of the invention. The paper web feed 200 and the cutter 202 each comprise a motor M which is controlled by respective control signals by the control 216. Further, modules 200, 204, 206 and 208 comprise sensors S, whose sensor signals are provided to the control, such that based on information from the paper web gathered by the sensor S in the paper web feed 200 from the printed paper web, as well as based on information from the gathering web from the sensors in modules 204, 206 and 208, control of motors M of the feed 200 and the cutter 202 can take place in order to adjust and keep the desired instants for cross cutting for generating the individual sheets by the cutter 202. The computer 210 has an interface that allows receiving the job description, i.e. a description of a job to be accomplished with respect to the compilation of groups etc. and inserting the same, wherein the job description is stored in the database 214. The control accesses information from the job description as well as information from the sensors to drive the motors for respective cutting of the paper web.

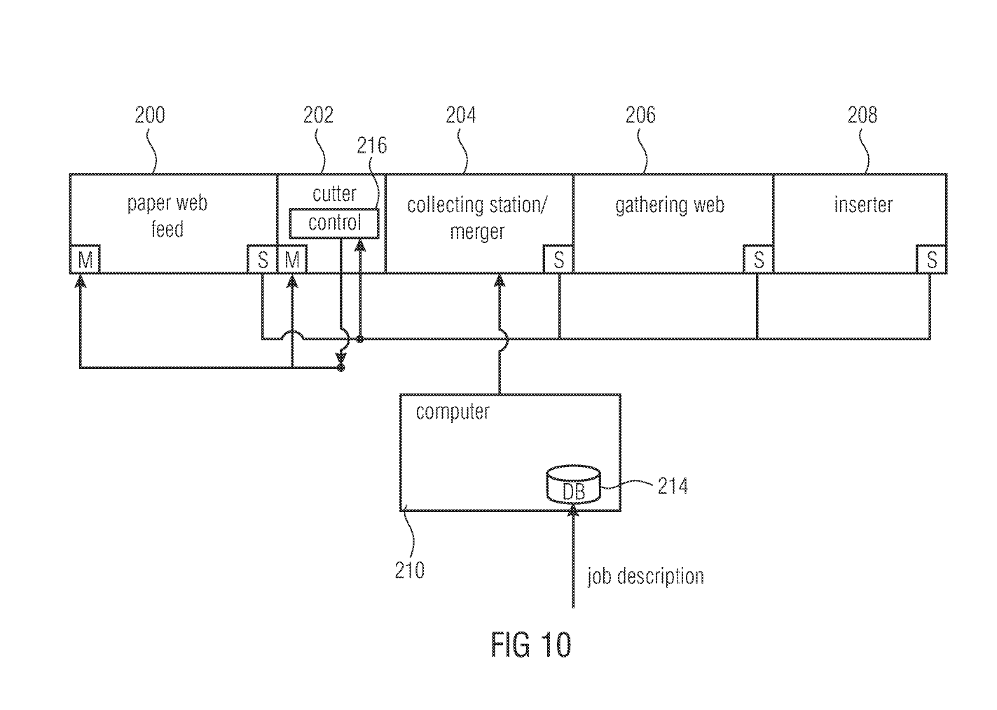

FIG. 10 is a schematic illustration of a paper handling plant according to a further embodiment of the invention where the control 216 is arranged in the cutter 202. The control 216 in the cutter 202 receives data from the above-described sensors and possibly from the database 214 and generates the necessitated control signals for the cutter and the other components and outputs the same based on these data in the above-described manner.

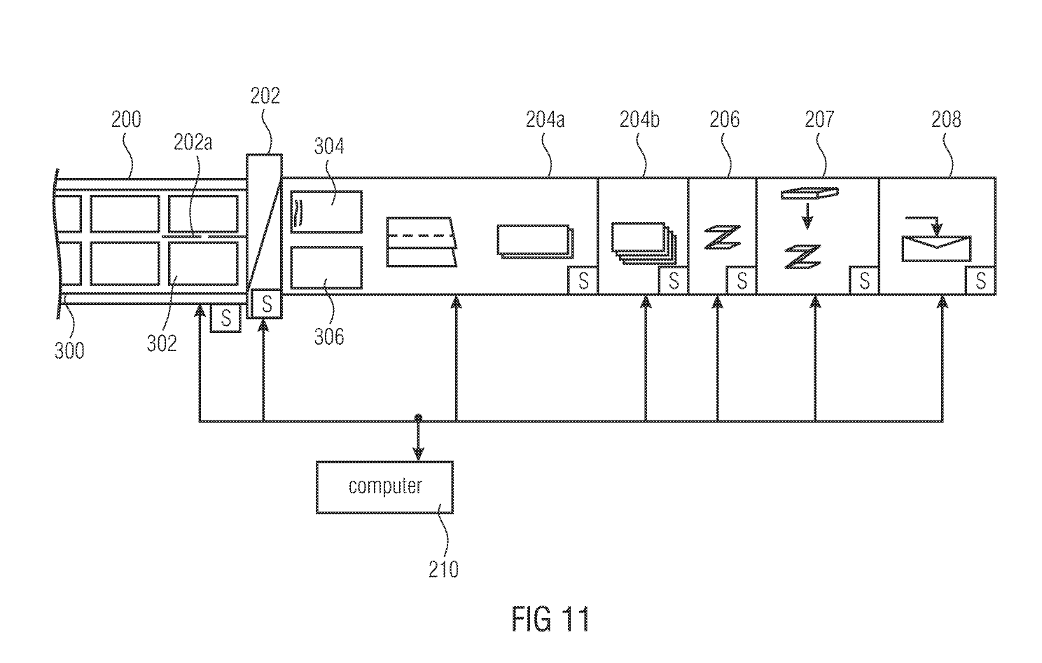

FIG. 11 shows an embodiment of a paper handling plant, where the paper web feed 200 serves to feed a paper web 300 to the plant, and which is printed in a two-use manner in the shown embodiment, i.e. the data for the individual sheets 302 are printed adjacent to each other on the paper web 300 (in cutting direction of the cutter 202). The cutter 202 comprises a cross cutter 202a cutting the paper web 300 between two adjacent prints, before the paper web 300 reaches the cross cutter 202 which separates the individual sheets from the paper web 300, as shown by individual sheets 304 and 306. In the merger 204a, the sheets are guided on top of each other and then transferred together into the collecting station 204b. In the embodiment shown in FIG. 11, a folding mechanism is provided, which receives sheet groups output from the collecting station 204b from its collecting tray, folds the same and outputs them to the gathering web 207. In the gathering web, additional sheets can be added to the group. The sheet groups are output by the gathering web 207 to an inserter 208. Control takes place again via the computer 210, in particular the control of the drive speed of the paper web and the knife 202.

In the embodiments described based on FIGS. 9, 10 and 11 for a paper handling plant, stopping or decelerating the paper web 300 is triggered, e.g., by information obtained from the paper web 300 itself or by an upstream reading (see the sensors in the apparatus 200 in FIGS. 9, 10 and 11) or from the database 214, as well as based on information from the subsequent process, e.g. based on the paper handling plant specific information or signals. For this, the cutting machine 210 is connected to the control 216 which performs the above-described inventive method, such that it can be detected what takes place or will take place in the downstream components 204, 206 and 208, e.g. an end of a group, free stopping positions, malfunctions and the same are detected. Detection either takes place “actively” by respective sensors or “passively” by calculation. The calculation is performed based on the first information and the second paper handling plant specific information. For example, a group end in a downstream component 204, 206 or 20 can be detected by a sensor detecting a last product in a group, e.g. by reading a code on the product or by recognizing the product (e.g. an imprint or part thereof). Alternatively or additionally to the sensors, calculation of the group end can be performed, based on the first information obtained, for example from a job description or from the paper web, as well as based on second paper handling plant specific information indicating, e.g. a speed at which a downstream component 204, 206 or 208 transports the products. The time between two cuts is then adjusted in an optimum manner by the control with respect to the respective situation. For example, the group change in the collecting station 204 can take longer than the arrival of the individual sheets at the collecting station during collection of the group. The end of a group or the start of the next group is either determined in advance by reading from the paper web 300 or by receiving/reading out the information from the database 214. When the material web 300 runs through the cutting machine 204, the time between two cuts can be extended based on this information, such that sufficient time is available for the subsequent process “group change” in the collecting station 204 based on this information to allow secure output from the collecting tray.

Another example is the utilization of the inserter. When the group performance of the input channel, consisting of components 200 to 206 exceeds the performance of the inserter 208, the time between two cuts has to be extended, which reduces the group performance of the input channel and hence adapts the same to the performance of the inserter. The information for this is again generated from a calculation of the cutting machine itself, by using read data or information from the database, in particular the information end of a group and/or start of a group, and from this, the average number of groups per time is determined that may not exceed the inserter performance. The information can also originate from a buffer for individual sheets or a buffer for sheet groups, where, for example, the filling level of the buffer has an influence on the information for the cutter machine. Direct information from the inserter itself can also be used. The information can also originate from the gathering web 207.

While several aspects have been described in the context of an apparatus, it is obvious that these aspects also represent a description of the respective method, such that a block or a component of an apparatus can also be seen as a respective method step or a feature of a method step. Analogously, aspects that have been described in the context of or as a method step also represent a description of a respective block or detail or feature of a respective apparatus.

Depending on specific implementation requirements, embodiments of the invention can be implemented in hardware or in software. The implementation can be performed by using a digital memory medium, for example a floppy disc, DVD, Blu-ray disc, CD, ROM, PROM, EPROM, EEPROM or FLASH memory, a hard drive or any other magnetic or optical memory on which electronically readable control signals are stored that can cooperate or cooperate with a programmable computer system such that the respective method is performed. Thus, the digital memory medium can be computer readable. Thus, some embodiments according to the invention comprise a data carrier comprising electronically readable control signals that are able to cooperate with a programmable computer system such that one of the methods described herein is performed.

Generally, embodiments of the present invention can be implemented as computer program products with a program code, wherein the program code is effective to perform one of the methods when the computer program product runs on a computer. The program code can, for example, also be stored on a machine-readable carrier.

Other embodiments comprise the computer program for performing one of the methods described herein, wherein the computer program is stored on a machine-readable carrier.

In other words, an embodiment of the inventive method is a computer program comprising a program code for performing one of the methods described herein, when the computer program runs on the computer. Another embodiment of the inventive method is a data carrier (or a digital memory medium or a computer-readable medium) on which the computer program for performing one of the methods described herein is recorded.

Thus, a further embodiment of the inventive method is a data stream or a sequence of signals representing the computer program for performing one of the methods described herein. The data stream or the sequence of signals can, for example, be configured in order to be transferred via a data communication link, for example, via the internet.

A further embodiment comprises a processing means, for example, a computer or a programmable logic device that is configured or adapted to perform one of the methods described herein.

A further embodiment comprises a computer on which the computer program for performing one of the methods described herein is installed.

In some embodiments, a programmable logic device (for example a field programmable gate array, FPGA) can be used to perform some or all functionalities of the methods described herein. In some embodiments, a field programmable gate array can cooperate with a microprocessor to perform one of the methods described herein. Generally, the methods in several embodiments are performed by means of any hardware device. This can be a universally inversely applicable hardware, such as a computer processor (CPU) or a hardware specific for the method, such as an ASIC.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A method for cutting a paper web during movement of the same for generating a plurality of individual sheets for processing by a paper handling plant, comprising:
driving the paper web at a high web speed; and
driving a rotary cutter to cut the moving paper web into the individual sheets;
wherein the paper web runs continuously between two cuts; and
wherein, in case of an event, the paper web can be stopped in a controlled manner prior to the next step.

2. The method according to claim 1, wherein the paper web is cut at successive cutting instants, wherein the interval between two immediately successive cutting instants defines a cutting cycle.

3. The method according to claim 1, wherein the paper web is decoupled between a paper supply and the rotary cutter, e.g. by at least one loop.

4. The method according to claim 1, wherein the paper web can be restarted immediately after stopping.

5. The method according to claim 1, wherein a feed drive for the paper web is implemented to stop the decoupled paper web within a cutting cycle in a controlled manner.

6. A method for controlling a rotary cutter for cutting a printed paper web during movement of the same for generating a plurality of individual sheets for processing by a paper handling plant, comprising:
feeding the printed paper web at a predetermined web speed; and
driving the rotary cutter at a predetermined cutter speed;
wherein prior to cutting the printed paper web for generating at least one predetermined individual sheet, a cutting instant for cross cutting the paper web is determined based on first information gathered from the printed paper web and/or from a job description, and based on second paper handling plant specific information;
wherein the web speed and/or the cutter speed are adjusted such that the paper web is cut at the specific cutting instant for generating the at least one predetermined individual sheet, and
wherein the paper web and the rotary cutter are stopped prior to reaching the determined cutting instant if a control signal indicates that a cut is undesired.

7. The method according to claim 6, wherein for the plurality of individual sheets to be generated, the respective cutting instants are determined predictively such that subsequent to the determination of the cutting instant for the at least one individual sheet, the cutting instant for at least one further individual sheet is determined, and the values determined for the at least one further individual sheet are provided for adjusting the web speed and/or the cutter speed.

8. The method according to claim 6, wherein the predetermined web speed and the predetermined cutter speed define a first time period between two successive cuts, and wherein determining the cutting instant comprises:
determining a second time period in which the at least one predetermined individual sheet is processed by the paper handling plant, based on the first information and the second paper handling plant specific information;
determining whether the second time period exceeds the first time period; and
if the second time period exceeds the first time period, adjusting the web speed and/or the cutter speed for generating an individual sheet following the at least one predetermined individual sheet such that the first time period is longer than or equal to the second time period.

9. The method according to claim 8, wherein adjusting the web speed and the cutter speed comprises reducing the predetermined web speed and/or the predetermined cutter speed.

10. The method according to claim 8 comprising:
if it is determined for an individual sheet following the at least one predetermined individual sheet that the second time period for processing is shorter than the first time period, increasing the web speed and/or the cutter speed.

11. The method according to claim 6, wherein the first information and the second paper handling plant specific information comprise the following parameters:
the individual sheets to be processed by the paper handling plant, and/or
the type of processing of the individual sheets in the paper handling plant, and/or
a capacity of the paper handling plant for processing the individual sheets.

12. The method according to claim 6, wherein the job description is provided by a database, wherein the job description comprises the parameters or second paper handling plant specific information from which the parameters can be derived, and/or wherein the paper web comprises the parameters or the second paper handling plant specific information from which the parameters can be derived.

13. The method according to claim 6, wherein the second paper handling plant specific information is gathered during operation of the paper handling plant for a plurality of individual sheets at different positions in the paper handling plant.

14. The method according to claim 6, comprising:
depending on one or several conditions, switching the cutter operation between continuous operation and start/stop operation.

15. The method according to claim 6, wherein, during continuous operation, the predetermined cutter speed is increased, independent of the predetermined web speed, for a shorter format of at least one individual sheet to be generated or is reduced for a longer format of at least one individual sheet to be generated.

16. The method according to claim 6, wherein the cutting instant for cross cutting the paper web is further determined based on third information indicating a malfunction or a malfunction event in the paper handling plant or in a module of the paper handling plant.

17. A computer program product comprising a computer program stored on a machine readable carrier for performing, when the computer program is executed on a computer or by a control, a method for cutting a paper web during movement of the same for generating a plurality of individual sheets for processing by a paper handling plant, comprising:
driving the paper web at a high web speed; and
driving a rotary cutter to cut the moving paper web into the individual sheets;
wherein the paper web runs continuously between two cuts; and
wherein, in case of an event, the paper web can be stopped in a controlled manner prior to the next step.

18. A paper handling plant for processing individual sheets in groups comprising one or several individual sheets, comprising:
a paper web feed for feeding the paper web to the paper handling plant;
a rotary cutter for cross cutting the paper web to generate the individual sheets for further processing in the paper handling plant;
one or several processing stations subsequent to the rotary cutter; and
a control that is effective to control the rotary cutter according to a method for cutting a paper web during movement of the same for generating a plurality of individual sheets for processing by a paper handling plant, the method comprising:
driving the paper web at a high web speed; and
driving a rotary cutter to cut the moving paper web into the individual sheets;
wherein the paper web runs continuously between two cuts; and
wherein, in case of an event, the paper web can be stopped in a controlled manner prior to the next step.

19. The paper handling plant according to claim 18 comprising a feed drive for the paper web, wherein the feed drive is implemented to stop the paper web in a controlled manner within a cutting cycle.
